(19) United States
(12) Patent Application Publication
(10) Pub. No.: US 2021/0364230 A1
(43) Pub. Date: Nov. 25, 2021

(54) METHOD FOR COOLING A SYSTEM IN THE 120K TO 200K RANGE

(71) Applicants: Air Liquide Advanced Technologies U.S. LLC, Houston, TX (US); L'Air Liquide, Société Anonyme pour l'Etude et l'Exploitation des Procédés Georges Claude, Paris (FR)

(72) Inventors: Gilles FLAVIEN, Grenoble (FR); Michael A. TUNEY, Houston, TX (US)

(21) Appl. No.: 17/326,126

(22) Filed: May 20, 2021

Related U.S. Application Data
(60) Provisional application No. 63/027,819, filed on May 20, 2020.

(51) Int. Cl. F25J 1/02; F25J 1/00

(52) U.S. Cl. CPC F25J 1/0224; F25J 1/0072; F25J 2210/90; F25J 1/0062; F25J 1/0082

(57) ABSTRACT

A system and method for cooling a liquid cryogenic fluid user with an inert and non-pressurized liquid cryogen in 120K to 200K temperature range is provided. This includes maintaining the first liquid cryogenic fluid within a first predetermined temperature range with the sub-cooler and/or the recirculation pump, maintaining the second liquid cryogenic fluid within a second predetermined temperature range with the heat exchanger, and recondensing the second liquid cryogenic fluid using the pressurized first liquid cryogenic fluid.

### CROSS REFERENCE TO RELATED APPLICATIONS

This application claims the benefit of priority under 35 U.S.C. § 119 (a) and (b) to U.S. Provisional Patent Application No. 63/027,819, filed May 20, 2020, the entire contents of which are incorporated herein by reference.

### BACKGROUND

Within the industry there is a need of an isothermal cooling in a temperature range comprised in 120K to 200K which is inert, low pressure and cost effective. In this range of temperatures the molecules that could be used (Nitrogen, Oxygen, Argon, Krypton, Xenon, Carbon dioxide, Methane, Ethane . . . ) all have some limitations that can be the price, the flammability, the high saturation pressure, or a combination of those, that make them inappropriate for the user.

An example of typical prior art for such application would utilize an inert refrigerant such as nitrogen in a single loop with indirect heat transfer with the user. However, the user demand for low pressure refrigeration results in temperatures which are colder than necessary. For example, N2 refrigerant at 1 bara yields evaporation temperature of ˜80K. This results in wasted refrigeration energy input through the range of 80K to 120K (or worse to 200K).

### SUMMARY

A system for cooling a liquid cryogenic fluid user with an inert and non-pressurized liquid cryogen in 120K to 200K temperature range is provided. The system includes a primary cooling loop having at least of a main cryogenic tank, one sub-cooler and a recirculation pump, and designed for operation with a first liquid cryogenic fluid under pressure. The primary pooling loop is connected to a secondary cooling loop composed of a liquid phase separator connected to the liquid cryogenic fluid user, the liquid phase separator housing a heat exchanger and designed to be operated at very low pressure with a second liquid cryogenic fluid. The secondary cooling loop is connected to a gaseous buffer tank thereby allowing the addition or removal of the second liquid cryogenic fluid from Secondary cooling loop during a cool-down and/or a warm-up phase. The system is configured to condense the second liquid cryogenic fluid using the pressurized first liquid cryogenic fluid.

A method for cooling a liquid cryogenic fluid user with an inert and non-pressurized liquid cryogen in 120K to 200K temperature range is provided. The method includes maintaining the first liquid cryogenic fluid within a first predetermined temperature range with the sub-cooler and/or the recirculation pump, maintaining the second liquid cryogenic fluid within a second predetermined temperature range with the heat exchanger, and recondensing the second liquid cryogenic fluid using the pressurized first liquid cryogenic fluid.

### BRIEF DESCRIPTION OF THE FIGURE

For a further understanding of the nature and objects for the present invention, reference should be made to the following detailed description, taken in conjunction with the accompanying drawing, in which like elements are given the same or analogous reference numbers and wherein:

FIG. 1 is a schematic representation of one embodiment of the present invention.

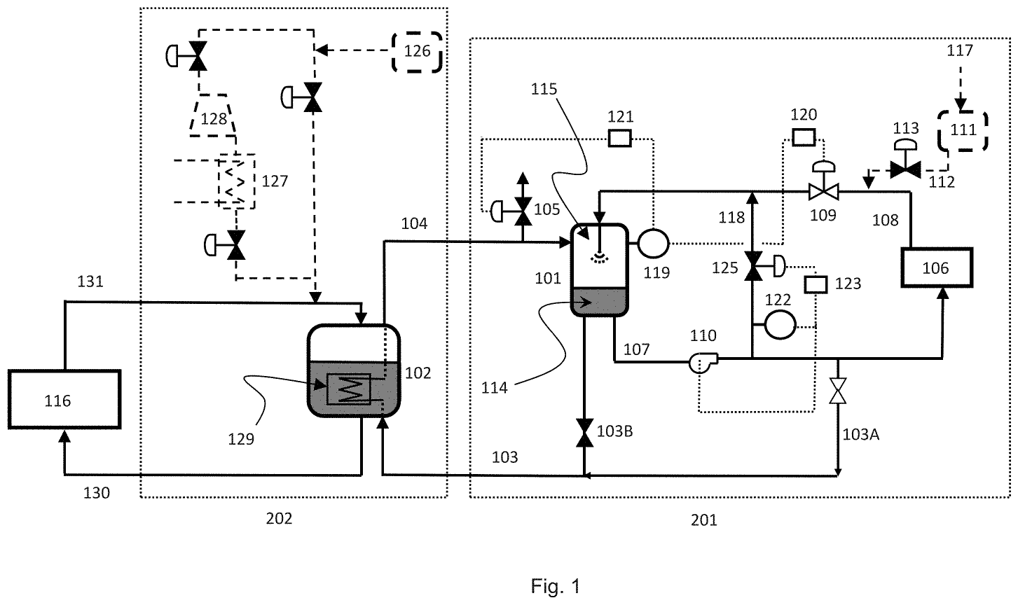

### ELEMENT NUMBERS

101=primary loop main cryogenic tank
102=secondary loop main cryogenic tank/liquid phase separator
103=liquid cryogenic fluid stream
104=vaporized cryogenic fluid stream
105=vent valve
106=sub-cooler
107=warm recirculation stream
108=subcooled recirculation stream
109=recirculation control valve
110=recirculation pump
111=liquid buffer tank
112=buffer tank transfer stream
113=buffer tank transfer control valve
114=liquid cryogenic fluid (in main cryogenic tank)
115=cryogenic fluid vapor (in main cryogenic tank)
116=liquid cryogenic fluid user
117=external liquid cryogenic fluid source
118=sub-cooler bypass line
119=first pressure transmitter (in primary loop main cryogenic tank)
120=first peripheral interface controller
121=second peripheral interface controller
122=second pressure transmitter (in sub-cooler bypass line)
123=third peripheral interface controller
124=fourth peripheral interface controller
125=bypass control valve
126=secondary loop gaseous buffer tank
127=secondary loop heater
128=secondary loop compressor
129=secondary loop main cryogenic tank coil/heat exchanger
130=cold secondary stream
131=warmed secondary stream
201=primary cooling loop
202=secondary cooling loop

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of this disclosure.

The system below describes the use of liquid nitrogen, but one skilled in the art will recognize that any suitable cryogenic fluid may be used with the same concept (oxygen, methane, etc. . . . ) depending on the temperature level required for cooling the targeted system.

One embodiment of the present invention is schematically illustrated in the sole figure. A reliquefaction system includes a primary cooling loop 201 which includes a primary loop main cryogenic tank 101, a liquid nitrogen stream 103, a vaporized nitrogen stream 104, and a vent valve 105 fluidically attached to vaporized nitrogen stream 104. The primary cooling loop also includes a sub-cooler 106, a warm recirculation stream 107, a sub-cooled recirculation stream 108, a recirculation control valve 109, and a recirculation pump 110. The primary cooling loop also includes a liquid buffer tank 111, a buffer tank transfer stream 112, and a buffer tank transfer control valve 113. Liquid buffer tank 111 may be refilled as needed from an external liquid nitrogen source 117, such as a liquid nitrogen truck trailer (not shown).

The reliquefaction system includes secondary cooling loop 202 which includes a secondary loop main cryogenic tank 102, secondary loop gaseous buffer tank 126, secondary loop heater 127, secondary loop compressor 128, and secondary loop main cryogenic tank coil 129.

Liquid nitrogen 114 is stored at saturated conditions (pressure P1) in primary loop main cryogenic tank 101. Nitrogen vapor 115 will occupy the headspace of primary loop main cryogenic tank 101. During normal operations, a portion of liquid nitrogen 114 is extracted from primary loop main cryogenic tank 101 and sent to secondary loop main cryogenic tank 102. Within secondary loop main cryogenic tank coil 129 liquid nitrogen stream 103 exchanges heat with liquid nitrogen stream 103 and thus provides internal refrigeration for secondary loop main cryogenic tank 102. As liquid nitrogen stream 103 passes through secondary loop main cryogenic tank coil 129 returning, at least partially vaporized stream 131 is at least partially condensed. Secondary loop main cryogenic tank 102 acts as a vapor/liquid phase separator. Liquid nitrogen stream 103 will thus be vaporized and vaporized nitrogen stream 104 will be recirculated primary loop main cryogenic tank 101.

Simultaneously, a portion of liquid nitrogen 114 is extracted from primary loop main cryogenic tank 101 as warm recirculation stream 107 and sent to recirculation pump 110. The pressurized liquid nitrogen then enters sub-cooler 106. Sub-cooler 106 will cool the liquid nitrogen by at least several degrees Celsius. This may be accomplished by any frigorific unit known in the art that can reach the required temperature level. Sub-cooled recirculation stream 108 is then returned to primary loop main cryogenic tank 101 where it is introduced into vapor phase 115 as a spray. When contacted with the sub-cooled liquid, vaporized nitrogen stream 104, returning from secondary loop main cryogenic tank 102, is cooled and condenses back to saturated liquid 114.

The lower the temperature downstream of sub-cooler 106, the lower the required pumped flow into sub-cooler 106 will be. Hence, utilizing the lowest practical downstream temperature will reduce the power consumed by recirculation pump 110, as well as simply reduce the size of recirculation pump 110, as well as reducing the size of the piping in stream 107 and 108, and inside exchanger 106. However, when approaching such a low sub-cooling temperature, typically at least 1 or 2 degree Celsius (possibly at least 3 degrees Celsius) above the freezing point of the cryogenic fluid at the internal pressure, presents challenges. For example, extreme care must be taken to ensure that there are a very few impurities in the nitrogen stream, especially argon which could freeze and disturb globally the overall process. In order to reach a level of sub-cooling lower than fourteen degree Celsius and preferably lower than ten degree Celsius above the freezing point of nitrogen, the argon content typically needs to be below 2% mol and preferably below 0.5% mol.

Primary loop main cryogenic tank 101 may include first pressure transmitter 119. First pressure transmitter 119 may interface with one or more peripheral interface controller (PIC). First PIC 120 is functionally connected to both first pressure transmitter 119 and recirculation control valve 109. Second PIC 121 is functionally connected to both first pressure transmitter 119 and vent valve 105. Sub-cooler bypass line 118, is fluidically connected to warm recirculation stream 107 and sub-cooled recirculation stream 108, thereby allowing at least a portion of the pressurized recirculation stream exiting recirculation pump 110 to bypass sub-cooler 106. Sub-cooler bypass line 118 may include second pressure transmitter 122. Second pressure transmitter 122 may interface with one or more PICs. Third PIC 123 is functionally connected to second pressure transmitter 122, bypass control valve 125, and recirculation pump 110. Alternatively, pressure at 119 may be controlled without bypass 118 by using a variable speed drive on pump 110.

The delivery pressure of liquid nitrogen stream 103 at the interface with secondary loop main cryogenic tank 102 may be linked with the pressure in primary loop main cryogenic tank 101. The pressure within primary loop main cryogenic tank 101 is primarily controlled by recirculation control valve 109 on the sub-cooled recirculation stream 108 exiting sub-cooler 106. First PIC 120 opens recirculation control valve 109 if first pressure transmitter 119 indicates that the pressure in primary loop main cryogenic tank 101 is low. First PIC 120 closes recirculation control valve 109 if first pressure transmitter 119 indicates that the pressure in primary loop main cryogenic tank 101 is high. The cooling capacity of sub-cooler 106 will adjust depending on the temperature at the outlet. The outlet temperature of sub-cooler 106 is directly impacted by the opening position of recirculation control valve 109 downstream. The greater the amount recirculation control valve 109 is open (meaning primary loop main cryogenic tank 101 pressure is high), the greater the temperature downstream sub-cooler 106 will tend to increase. And thus, the cooling capacity of the sub-cooler 106 will be increased.

Recirculation pump 110 may be a variable frequency drive (VFD) type pump. The speed of recirculation pump 110 is controlled by third PIC 123 which will accelerate the pump if the pressure read by second pressure transmitter 122 in the sub-cooling line is low (meaning that the sub-cooling flow is increasing).

If sub-cooler 106 is unable to provide sufficient cooling capacity to compensate for the refrigeration load demanded by secondary loop main cryogenic tank 102, the pressure in the cooling loop will increase. In order to prevent the pressure to rise over a desired or predetermined level which could impact secondary loop main cryogenic tank 102, vent valve 105 is installed on vaporized nitrogen stream vaporized nitrogen stream 104 returning from secondary loop main cryogenic tank 102 to primary loop main cryogenic tank 101. Obtaining feedback from first pressure transmitter 119, second PIC 121 instructs vent valve 105 to open in order to reduce, and/or regulate the pressure in primary loop main cryogenic tank 101. Vent valve 105 may be installed in between 2 valves (not shown) to be connected to primary loop main cryogenic tank 101 only, or to vaporized nitrogen stream 104 only.

The sub-cooling system does not necessarily fully compensate the heat load from the user. It can be of a lower capacity than the heat load by design, it can underperform or be stopped because of a failure or a maintenance, or it can be slowed down on purpose if the trade-off between electrical consumption costs versus the availability of liquid nitrogen becomes interesting.

When the flow in sub-cooled recirculation stream 106 or warm recirculating stream 107 is reduced or stopped, liquid cryogenic fluid stream 103 to secondary loop main cryogenic tank 102 is maintained by means of primary loop main cryogenic tank 101. The pressure within liquid cryogenic fluid stream 103 and vaporized cryogenic fluid stream 104 will tend to increase due to the cooling load from the user not being compensated by sub-cooler 106. Vent valve 105 will open as required to maintain the desired constant tank pressure.

Liquid buffer Tank 111 is used to isolate the cooling loop (i.e. sub-cooled recirculation stream 106 or warm recirculating stream 107) from perturbations generated by liquid nitrogen transfers from external liquid nitrogen source 117 (such as Trailers loading the loop). The liquid nitrogen inventory in this liquid buffer tank 111 can also be used to maintain the liquid nitrogen supply in sub-cooled recirculation stream 106 and warm recirculating stream 107 when the flow through sub-cooling system is reduced or stopped. The pressure in the liquid buffer tank 111 is controlled by a pressure build-up coil (not shown), while liquid nitrogen is transferred to primary loop main cryogenic tank 101.

In one embodiment of the present invention, refrigeration duty is provided to liquid cryogenic fluid user 116 by means of an inert liquid within the desired temperature in the range of 120K-200K and at low pressure. This avoids supplying colder than desired temperatures and thus providing inefficient cooling. The overall cooling efficiency is thus improved.

The proposed solution consists of using two cooling loops 201/202, which are thermally integrated. Primary cooling loop 201 may use a cryogenic fluid which may be flammable and maintained under higher pressure. This allows using relatively inexpensive fluids such as nitrogen or methane for instance. Primary cooling loop 201 is composed of primary loop main cryogenic tank and at least one sub-cooler 106 to sub-cool the liquid cryogen.

The pressurized sub-cooled liquid cryogen 108 generated in the primary cooling loop is then introduced to secondary loop main cryogenic tank coil 129 which exchanges heat with secondary cooling loop 202. The transfer of the pressurized sub-cooled liquid cryogen to the heat exchanger can be performed either by using transfer pumps or simply by gravity. Secondary cooling loop 202 will typically consist of a much smaller closed circuit having a secondary loop main cryogenic tank 102, housing secondary loop main cryogenic tank coil 129, and providing refrigerant to liquid cryogenic fluid user 116.

The specific cryogen that is used in secondary loop 202 may be chosen among more expensive, inert cryogens, that have a saturation temperature comprised in the range 120K-200K at low pressure. The following table lists the possible cryogens combinations and process conditions:

| User required cooling | | | | | | | |
|---|---|---|---|---|---|---|---|
| conditions | | Primary Cooling Loop | | | Secondary Cooling Loop | | |
| | Temperature | Cryogenic | Saturation | Saturation | | Saturation | Saturation |
| Pressure | Range | Fluid | Pressure | Temperature | Cryogenic Fluid | Pressure | Temperature |
| 1 bara ± 1 bar | 120 K to 140 K | Nitrogen | 18.5 bara ± 5 bar | 115 K ± 5 K | Krypton (Kr) | 1 bara ± 1 bar | 120 K ± 5 K |
| | | (N2) | | | | | |
| 1 bara ± 1 bar | 140 K to 165 K | Methane | 6.5 bara ± 5 bar | 140 K ± 5 K | Tetrafluoride | 1 bara ± 1 bar | 140 K ± 5 K |
| | | (CH4) | | | (CF4) | | |
| 1 bara ± 1 bar | 165 K to 185 K | Methane | 15.5 bara ± 5 bar | 160 K ± 5 K | Xenon (Xe) | 1 bara ± 1 bar | 165 K ± 5 K |
| | | (CH4) | | | | | |
| 1 bara ± 1 bar | 185 K to 200 K | Methane | 33 bara ± 5 bar | 180 K ± 5 K | Dinitrogen | 1 bara ± 1 bar | 185 K ± 5 K |
| | | (CH4) | | | Monoxide (N2O) | | |

As a non-limiting example, consider the following system wherein methane is used as the primary cooling loop fluid and xenon is used as the secondary cooling loop fluid.

As the cooling phase is set to begin, primary loop main cryogenic tank 101 is filled with a predetermined amount of methane at a pressure of slightly greater than 15.5 bara (±5 bar) in order to maintain the methane in the fully saturated phase. Secondary loop main cryogenic tank 102 is filled with a predetermined amount of xenon at a pressure of slightly greater than 1 bara (±1 bar) in order to maintain the xenon in the fully saturated phase.

As described above, a first portion of the saturated methane exits primary loop main cryogenic tank 101 as warm recirculation stream 107, is pressurized in recirculation pump 110, and either bypasses sub-cooler 106 through sub-cooler bypass line 118 or passes through sub-cooler 106, as needed to maintain the desired temperature. The sub-cooled methane exits sub-cooler 106 through sub-cooled recirculation stream 108 and is readmitted into primary loop main cryogenic tank 101 as it is sprayed into cryogenic fluid vapor space 115.

A second portion of the saturated methane exits primary loop main cryogenic tank 101, again as warm recirculation stream 107, but this portion passes through liquid cryogenic stream 103A and then enters secondary loop main cryogenic tank coil 129. As liquid cryogenic stream 103A passes through secondary loop main cryogenic tank coil 129 it cools the xenon that is contained with secondary loop main cryogenic tank 102 and is itself warmed and typically vaporized 104. Vaporized cryogenic fluid stream 104 is then returned to primary loop main cryogenic tank 101, wherein it comes into direct heat exchange with sub-cooled recirculation stream 108 as it is sprayed into cryogenic fluid vapor space 115.

As heat is transferred into liquid cryogenic fluid stream 103A, the saturation temperature (and hence the saturation pressure) within secondary loop main cryogenic tank 102 is achieved and/or maintained. A portion of cold secondary stream 130 is directed to liquid cryogenic fluid user 116. Liquid nitrogen user 116 will utilize cold secondary stream 130 for internal refrigeration purposes. Cold secondary stream 130 will thus be warmed, and typically vaporized. Warmed secondary stream 131 will be recirculated to secondary loop main cryogenic tank 102.

As the warming phase is set to begin, the flow rate of second portion of the saturated that had been flowing through secondary loop main cryogenic tank coil 129 is reduced then stopped. As no heat is being transferred out of secondary loop main cryogenic tank 102, the saturation temperature within secondary loop main cryogenic tank 102 is no longer maintained. As the portion of cold secondary stream 130 continues to be directed to liquid cryogenic fluid user 116, warmed secondary stream 131 is now re-directed into secondary loop gaseous buffer tank 126. Warmed secondary stream 131 passes through secondary loop heater 127 wherein it is fully vaporized and/or superheated, then through secondary loop compressor 128 which increases the stream pressure and allows it to be introduced into secondary loop gaseous buffer tank 126. Thus, the predetermined amount of saturated liquid supply of xenon that was initially held in secondary loop main cryogenic tank 102 is depleted and is transferred into secondary loop gaseous buffer tank 126.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed:

1. A system for cooling a liquid cryogenic fluid user with an inert and non-pressurized liquid cryogen in 120K to 200K temperature range comprising:
a primary cooling loop composed at least of a main cryogenic tank, one sub-cooler and a recirculation pump, and designed for operation with a first liquid cryogenic fluid under pressure,
wherein
the primary pooling loop is connected to a secondary cooling loop composed of a liquid phase separator connected to the liquid cryogenic fluid user, the liquid phase separator housing a heat exchanger and designed to be operated at very low pressure with a second liquid cryogenic fluid,
the secondary cooling loop is connected to a gaseous buffer tank thereby allowing the addition or removal of the second liquid cryogenic fluid from Secondary cooling loop during a cool-down and/or a warm-up phase, and
the system is configured to condense the second liquid cryogenic fluid using the pressurized first liquid cryogenic fluid.

2. The system of claim 1, wherein the first liquid cryogenic fluid is liquid nitrogen.

3. The system of claim 1, wherein the second liquid cryogenic fluid is liquid krypton.

4. The system of claim 1 where the first liquid cryogenic fluid is methane, and wherein the second liquid cryogenic fluid is tetrafluoride.

5. The system of claim 1 where the first liquid cryogenic fluid is Methane, and wherein the second liquid cryogenic fluid is xenon.

6. The system of claim 1 where the first liquid cryogenic fluid is Methane, and wherein the second liquid cryogenic fluid is dinitrogen monoxide.

7. A method for cooling a liquid cryogenic fluid user with an inert and non-pressurized liquid cryogen in 120K to 200K temperature range comprising:
a primary cooling loop composed at least of a main cryogenic tank, one sub-cooler and a recirculation pump, and designed for operation with a first liquid cryogenic fluid under pressure, and
a secondary cooling loop composed of a liquid phase separator connected to the liquid cryogenic fluid user, the liquid phase separator housing a heat exchanger and designed to be operated at very low pressure with a second liquid cryogenic fluid,
the method comprising:
maintaining the first liquid cryogenic fluid within a first predetermined temperature range with the sub-cooler and/or the recirculation pump,
maintaining the second liquid cryogenic fluid within a second predetermined temperature range with the heat exchanger, and
recondensing the second liquid cryogenic fluid using the pressurized first liquid cryogenic fluid.

8. The method of claim 7, wherein the first liquid cryogenic fluid is liquid nitrogen.

9. The method of claim 7, wherein the second liquid cryogenic fluid is liquid krypton.

10. The method of claim 7 where the first liquid cryogenic fluid is methane, and wherein the second liquid cryogenic fluid is tetrafluoride.

11. The method of claim 7 where the first liquid cryogenic fluid is Methane, and wherein the second liquid cryogenic fluid is xenon.

12. The method of claim 7 where the first liquid cryogenic fluid is Methane, and wherein the second liquid cryogenic fluid is dinitrogen monoxide.
